(19) United States
(12) Patent Application Publication
(10) Pub. No.: US 2022/0179903 A1
(43) Pub. Date: Jun. 9, 2022

(54) METHOD/SYSTEM FOR EXTRACTING AND AGGREGATING DEMOGRAPHIC FEATURES WITH THEIR SPATIAL DISTRIBUTION FROM AUDIO STREAMS RECORDED IN A CROWDED ENVIRONMENT

(71) Applicant: International Business Machines Corporation, Armonk, NY (US)

(72) Inventors: Gabriele Picco, Dublin (IE); Joao H Bettencourt-Silva, Dublin (IE); Thanh Lam Hoang, Maynooth (IE); Marco Luca Sbodio, Castaheany (IE)

(21) Appl. No.: 17/116,048

(22) Filed: Dec. 9, 2020

(51) Int. Cl. G06F 16/61; G10L 25/51; G10L 25/84; G06N 20/00

(52) U.S. Cl. CPC G06F 16/61; G06N 20/00; G10L 25/84; G10L 25/51

(57) ABSTRACT

Extracting demographic features from audio streams in a crowd environment includes receiving audio stream signals from a predefined geographical area containing a plurality of individuals, recording the received audio stream signals, extracting demographic features from the recorded audio stream signals, aggregating the extracted demographic features, storing the aggregated demographic features in a database and analyzing aggregated demographic features to generate a summary of demographic characteristics of the plurality of individuals in the predefined geographical area. Demographic features may be aggregated at different levels of granularity. The method and system may include extracting spatial information of the recorded audio stream signals within the geographical area, determining spatial distribution of the aggregated demographic features within the geographical area based on the extracted spatial information and including the spatial distribution in the summary of demographic characteristics. The evolution over time of the aggregated demographic features may be predicted using a machine learning model.

### BACKGROUND OF THE INVENTION

This disclosure is directed to computers, and computer applications, and more particularly to computer-implemented methods and systems for extracting and aggregating demographic features with their spatial distribution from audio streams recorded in a crowded environment.

It is well understood that product preferences vary across different groups of consumers. These preferences relate directly to consumer demographic characteristics, such as age and gender. Typically, governmental agencies collect demographic data when conducting a national census and companies use that demographic data to predict and target consumer choices and buying preferences. Demographic data may also be collected from a myriad of apps, social media platforms, third party data collectors, retailers, and financial transaction processors.

There are various environmental or geographical spaces where there are multiple persons forming a crowd, such as conferences, corporate and social outings, sporting events, etc. The demographic characteristics of a crowd in such an environment would be important for usage in predictive analytics, for example for advertisement, customer engagement and churn prediction. However, the data collection methods described above cannot provide the demographic characteristics such a crowd.

### SUMMARY OF THE INVENTION

In one embodiment, a computer implemented method is disclosed for extracting demographic features from audio streams in a crowd environment. The method includes the steps of receiving audio stream signals from a predefined geographical area containing a plurality of individuals; recording the received audio stream signals; extracting demographic features from the recorded audio stream signals; aggregating the extracted demographic features; storing the aggregated demographic features in a database; and analyzing the aggregated demographic features to generate a summary of demographic characteristics of the plurality of individuals in the predefined geographical area. The method may also include in one embodiment, separating the recorded audio stream signals into individual speaker streams. The method may also include in one embodiment extracting spatial information of the recorded audio stream signals within the geographical area; determining spatial distribution of the aggregated demographic features within the geographical area based on the extracted spatial information and including the spatial distribution in the summary of demographic characteristics. The method may also include in one embodiment predicting an evolution over time of the aggregated demographic features and using a machine learning model to predict the evolution over time of the aggregated demographic features. The method may also include in one embodiment aggregating the extracted demographic features at different levels of granularity. In one embodiment the audio signal streams are received by a plurality of microphones arranged in a grid at known locations within geographical area.

A computer system that includes one or more processors operable to perform one or more methods described herein also may be provided.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of one embodiment of the system disclosed in this specification.

FIG. 2 is a schematic diagram of a crowd environment having a grid of microphones according to one embodiment disclosed in this specification.

FIG. 3 is a choropleth map of aggregated demographic features according to one embodiment disclosed in this specification.

FIG. 4 is a flow diagram of one embodiment of the method disclosed in this specification.

FIG. 5 is a flow diagram of one embodiment of the method disclosed in this specification.

FIG. 6 is a block diagram of an exemplary computing system suitable for implementation of the embodiments of the invention disclosed in this specification.

### DETAILED DESCRIPTION OF PREFERRED EMBODIMENTS

In one embodiment, a method and system is disclosed that extracts and aggregates demographics features of participants in an environment or geographical space where there are multiple persons forming a crowd. In one embodiment, audio stream signals are obtained from the participants in the environment/space from recordings or real time audio from the environment/space. In one embodiment, the audio stream signals are recorded from multiple microphones arranged in a grid covering the environment/space. In one embodiment, the audio stream signals are decomposed into individual speaker streams to identify the speakers.

In one embodiment an algorithm is applied to extract demographic features from each of the individual speaker streams. In one embodiment, the spatial distribution of the individual speaker streams is determined and the demographic features are aggregated with their spatial distribution in the environment in order to analyze the crowd for usage in predictive analytics, for example for advertisement, customer engagement and churn prediction.

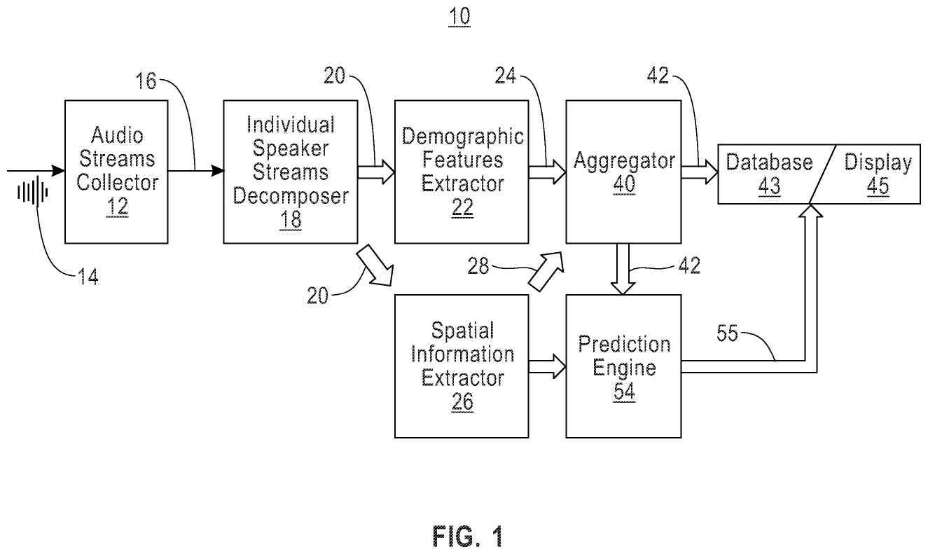

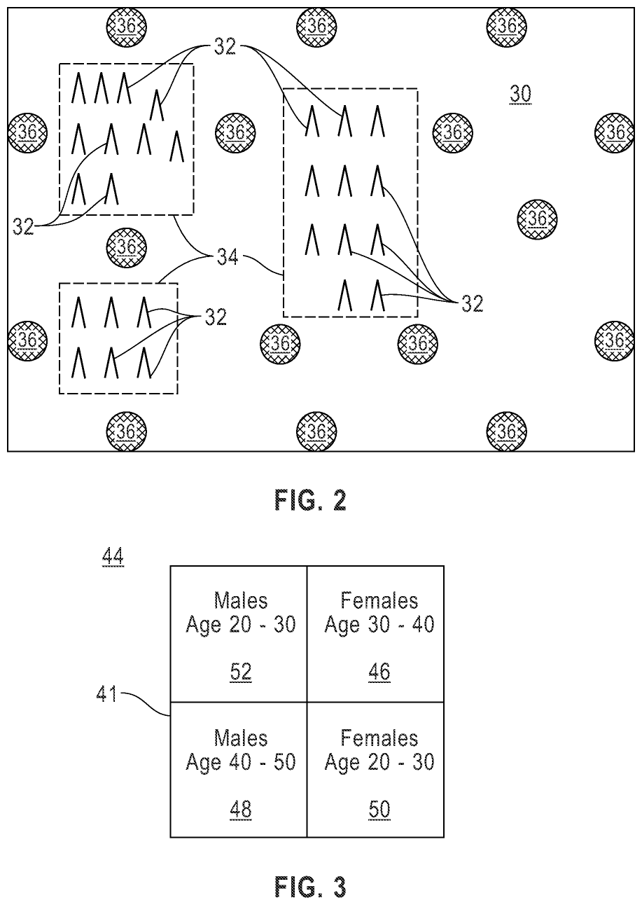

FIG. 1 is one embodiment of a system 10 for extracting and aggregating demographics features of participants in an environment or geographical space. The system 10 includes an audio streams collector 12 that receives audio stream signals 14. In one embodiment, the audio streams collector 12 collects the audio stream signals 14 from a grid of microphones 36 covering the environment space 30 shown in FIG. 2. In one embodiment, the location of the microphones 36 is known relative to the map of the environment space 30. In one embodiment, the audio stream signals are aggregated by the audio steams collector 12, keeping the information about the source, such as the location of the microphone or recording device, type of device recording device such as a phone or smart speaker, and other information specific to the audio input. The audio streams collector 12 generates an output 16 of a mixture of audio stream signals and source information. In one embodiment, the aggregation of the audio stream signals 14 can be a simple union in a database of all the streams coming from different microphones 36. In one embodiment, the aggregation consists in forwarding the streams to a midway point, together with the information relating to the position of the microphone (if known), the type of source and the other specific information, such as: microphone in the bar area or microphone above the clothes shelf.

The output signals 16 from the audio streams collector 12 are input to individual speaker streams decomposer 18. Audio streams from individuals in a crowd often takes place in the presence of interfering speakers, requiring the ability to separate the voice of a particular speaker from the mixed audio signal of others. In one embodiment, the individual speaker streams decomposer 18 separates the mixture of audio stream signals into individual audio stream signals 20, for example, one audio stream for each person in the crowd.

In one embodiment, the signals from each microphone are decomposed into independent components using methods such as independent component analysis (ICA). The ICA output is a set of signals that correspond to individual voice from each detected person. In one embodiment, after the stream decomposition step, a signal de-duplication component can be added to identify the signals belonging to the same person/source (based on distances e.g. dynamic time warping or simple Euclidean distance). Features generated from duplicate streams are merged.

In one embodiment the individual speaker streams decomposer 18 uses a neural network to separate the mixture of audio stream signals into individual audio stream signals. In one embodiment, a neural network is used to project the time-frequency representation of the mixture signal into a high-dimensional embedding space. A reference point is created in the embedding space to represent each speaker which is defined as the centroid of the speaker in the embedding space. The time-frequency embeddings of each speaker are then forced to cluster around the corresponding attractor point which is used to determine the time-frequency assignment of the speaker. The objective function for the network is signal reconstruction error which enables end-to-end operation during both training and test phases. Two deep learning methods, deep clustering and permutation invariant training may be used. In deep clustering, a network is trained to generate a discriminative embedding for each time-frequency bin so that the embeddings of the bins that belong to the same speaker are closer to each other. The permutation invariant training algorithm solves the permutation problem by first calculating the training objective loss for all possible permutations for the mixing sources and then using the permutation with the lowest error to update the network.

In one embodiment, the voice of a target speaker can be separated from multi-speaker signals by making use of a reference signal from the target speaker for training two separate neural networks. The first network is a speaker recognition network that produces speaker-discriminative embeddings and the second network is a spectrogram masking network that takes both noisy spectrogram and speaker embedding as input, and produces a mask. The system may include two separately trained components: a speaker encoder and the voice filter which uses the output of the speaker encoder as an additional input. The purpose of the speaker encoder is to produce a speaker embedding from an audio sample of the target speaker. The voice filter system is a neural network that takes two inputs: a d-vector of the target speaker, and a magnitude spectrogram computed from a noisy audio. The network predicts a soft mask, which is element-wise multiplied with the input (noisy) magnitude spectrogram to produce an enhanced magnitude spectrogram. To obtain the enhanced waveform, the phase of the noisy audio is merged to the enhanced magnitude spectrogram. The network is trained to minimize the difference between the masked magnitude spectrogram and the target magnitude spectrogram computed from the clean audio.

In one embodiment the individual speaker streams decomposer 18 may also estimate the number of people in the crowd to further improve the accuracy of the separations into individual audio stream. In one embodiment, the number of people talking in an environment space can be estimated through unsupervised machine learning analysis on audio stream signals output 16 from the audio streams collector 12. The number of people in the crowd can be inferred from the analysis of the voices contained in the audio streams captured by the microphones 36 used by the audio stream collector 12, without any prior knowledge of the speakers and their speech characteristics. This method may be used in conjunction with other methods such as counting the number of WiFi devices associated with an access point, a Bluetooth scan result and/or computer vision techniques to analyze the number of people in video images. In one embodiment, a speech detection phase extracts the speech segments from the audio data by filtering out silence periods and background noise. In a feature extraction phase, feature vectors are computed from the active speech data. In a counting phase, a distance function is used to maximize the dissimilarity between different speakers' voice, and then an unsupervised learning technique is applied that, operating on the feature vectors with the support of the distance function, determines the speaker count.

The individual audio stream signals 20 are input to a demographic features extractor 22. The demographic features extractor 22 extracts demographic features, such as age and gender, as well as other known demographic features, from the individual audio stream signals 20. Methods for demographic recognition are used to identify gender, accent, age etc. associated with each individual speaker stream signal 20. The demographic features extractor 22 outputs individual demographic features data 24.

In one embodiment, demographic features extractor 22 extracts gender based on two acoustic features (pitch and first formant) or by a modified voice contour (MVC) area method. In one embodiment, a speech signal of individual speakers of the individual audio stream signals 20 in the time domain is considered and provides a single value in the form of area under the MVC. Background/environmental noise in speech based applications can degrade the performance. To take into account the noise, a white noise at different sound-to-noise ratio (SNR) levels is added in the speech signal. The voice intensity of the speech signal using the MVC is determined. Simpson's rule is used to calculate the area under the MVC. The MVC is obtained after adding a factor in a polynomial of degree three that is fitted through the peaks. The peaks are found from each frame when a speech utterance is blocked into frames. At the end, the calculated area is fed to a Support Vector Machine (SVM) to make the decision about the type of gender.

In one embodiment, age may be obtained by a fuzzy-based decision fusion strategy. In one embodiment, speech data obtained from the individual audio stream signals 20 are divided into groups based on different vowel classes that contain complementary sets of information for age estimation. The classifiers are applied on each group to make a primary decision. Subsequently, fuzzy data fusion is employed to provide an overall decision by aggregating the classifier's outputs. Different vowels uttered by each speaker provide diverse sources of information, which are employed for estimation of speaker's age. Dealing with the age estimation problem, vowel-based age estimation is employed for classifier fusion. In order to perform age classification in a fully automated manner, a SVM based vowel classifier with a linear kernel is developed for age classification to divide the testing samples into the vowel classes. Before dividing the test samples a vowel classifier is trained with the training samples of the age classifier. The only difference between the age classifiers and the vowel classifier is the training labels that show the vowel class to the vowel classifier. Based on this technique, without having prior phonetic knowledge of a testing sample, its age class can be predicted.

The individual audio stream signals 20 are also input to spatial information extractor 26. The spatial information extractor 26 extracts spatial information of individual audio stream signals 20. The spatial information extractor 26 outputs individual spatial information data 28. In one embodiment, the spatial information extractor 26 uses the known position of the grid of microphones 36 and applies triangulation techniques. In one example shown in FIG. 2, the geographical area 30 has participants 32 that form a crowd. The participants may gather in clusters 34. Speakers 36 are arranged in a grid within space 30. In one embodiment, the speakers 36 may be nodes equipped with microphone arrays. Each node 36 calculates concurrent angular speaker detections from individual audio stream signals 20 and transmits the spatial and spectral estimates to the spatial information extractor 24, which uses the spectral information to solve the ambiguity problem for multiple simultaneous detections for multiple concurrent speakers. The angular estimates are used to integrate the localizations over time. Euclidean coordinates are calculated by triangulation. In one embodiment, a precision oriented weighting is introduced that allows the integration of an arbitrary number of nodes 36.

In one embodiment, a cochlear and mid-brain model uses frequency bands from the individual audio stream signals 20. For pre-defined time windows, a set of combined tuples with azimuth and spectrum is extracted as set of speech detections. Speaker sources are estimated by calculating clusters 34 with mean angle deviation and spectrum from the detections in the current and adjacent time frames. The probability of an audio stream to originate from a particular source 32 is determined from the angular probability density for a detection that is calculated using the angular distance and the spectral similarity of a detection to a model spectrum that is calculated as a normalized scalar product. The number of sources 32 can be estimated by observing the typical variance of speaker localizations for the given array geometry. If the source is split into two sources, when two estimates get closer than a threshold, the sources are merged. After this step, there are clustered source estimates for each time frame at each node 36. To associate the estimates from different nodes 36, their spectra are correlated and the pairs with the strongest correlation are computed. By thereafter combining all pairs with common angles, sets of angular estimates over all nodes 36 are derived. The Euclidean position of the source 32 can be derived by triangulation using these sets. By calculating the intersection of the lines originating at two nodes' 36 center positions with the angles of the clusters 34, the 2D position is derived. Given two angles, the quality of the localization by intersection may be expressed to reflect the fact that an angular difference of 90° yields the highest precision and an angular difference near 0° or 180° the worst precision. In order to calculate one point from multiple intersections, a weighted sum is used. For each set of new estimates, the track with the highest likelihood above a threshold is chosen from all tracks not older than a preset time.

The individual demographic features data 24 and the individual spatial information data 28 are input to aggregator 40. Data aggregation is the process where raw data is gathered and expressed in a summary form for statistical analysis. The aggregator 40 performs both temporal and spatial data aggregation. In temporal aggregation, all data points for a single speaker 32 are aggregated over a specified time period. In spatial aggregation, all data points for a group of speakers 32 are aggregated over a specified time period. Granularity is the period over which data points for a given speaker resource or set of speaker resources (individual or microphone array 36) are collected for aggregation. The aggregator 40 aggregates the individual demographic features 24 and analyzes the aggregated demographic features to generate aggregated demographic feature data 42. In one embodiment, the aggregated demographic feature data 42 is in the form of a summary of demographic characteristics of the plurality of individuals in the predefined geographical area. In one embodiment, the aggregated demographic feature data 42 are stored in a database 43 and/or displayed on display 45. In one embodiment, aggregator 40 aggregates the individual demographic features 24 to different levels of granularity. For example, a different level of granularity could be applied for age ranges as compared to the level of granularity for country of origin or nationality.

In one embodiment, the aggregator 40 enriches the aggregated demographic features with information about their spatial distribution in the environment obtained from spatial information extractor 26. In one embodiment, the aggregator 40 aggregates the individual spatial information 28 based on the criteria used for the demographic features segmentation used by spatial information extractor 26. In one embodiment, the aggregator 40 aggregates the individual demographic features data 24 based on the spatial distribution information using the individual spatial information data 28. This information is aggregated across different microphones 36 to form final spatial-temporal demographic information.

In one embodiment, additional information on the environment can be used to enrich the aggregated demographic features with spatial information data 28 and related properties of the environment. For example, in a supermarket, having the spatial distribution, it would be possible to enrich the aggregated demographic features with information about proximity to a specific area/department/product, for example, “women over the age of 50 in the food department”. In one embodiment, aggregator 40 applies an aggregation function that considers gender and nationality together to form aggregate features of different granularity, such as, European women, American men. Another aggregation function could also consider nationality and age, making possible features such as: “American men between 25 and 40.” The aggregator 40 may apply aggregation functions that use one or more features. In turn the features can be transformed by one or more aggregation functions. In one embodiment, the aggregation functions can aggregate by combining demographic features (simple or aggregated) into features with different granularity, such as “European males between the ages 25 and 35 in the area determined by the centre with coordinates 53.3498° N 6.2603 W and radius 20 meters”, or “women over the age of 50 in the food department”.

In one embodiment, aggregator 40 a system of hardware and software components that are used to aggregate data from the demographic features extractor 22 and the spatial information extractor 26. Aggregator 40 may aggregate data as a service to subscribing clients. The data aggregation service may, for example, be implemented as a Web service or a Cloud service. Aggregator 40 may perform one or more of parsing, partitioning, indexing and archiving of the data to generate a report of based on the summary of the demographic characteristics. The report may be customized based on the client request. In one embodiment, aggregator 40 may perform hierarchy parsing to combine the individual demographic features and the individual spatial information to generate a global tree structure. In one embodiment, aggregator 40 may generate a data access plan for fetching data requested by a client. The data access plan includes data access requirements to fetch appropriate data from appropriate data sources 36 to fulfill a client data request.

In one embodiment, the aggregator 40 computes one or more choropleth maps of the simple or aggregated demographic features. A choropleth map will have sub-areas within the geographic space identified, for example by coloring or patterning, in proportion to a statistical variable that represents an aggregate summary of the demographic features within each sub-area. FIG. 3 is one example of a choropleth map 44 for a geographic area 41. For example, the area 41 can be a conference setting with four different concurrent presentations being held in four different rooms. A first quadrant 46 represents a first room that has males in age range 20-30, a second quadrant 48 represents a second room that has females in age range 30-40, a third quadrant 50 represents a third room that has males in age range 40-50 and a fourth quadrant 52 represents a fourth room that has females in age range 20-30. In one embodiment, the choropleth map may also combine age and gender with country of origin. For example, in one embodiment, for a commercial center, multiple choropleth maps are shown to highlight demographics features (age/gender/nationality) and aggregated features over different shops/areas.

In one embodiment, the aggregated demographic features data 42 are also input to prediction engine 54. Prediction engine 54 predicts the evolution of the aggregated demographic features 42 over time. In one embodiment, the prediction engine 54 predicts the evolution of the spatial distribution of the aggregated demographic features 42 over time. In one embodiment, the prediction data 55 output from prediction engine 54 may be stored in the database 43 and/or displayed on display 45. In one embodiment, the prediction engine 54 uses a machine learning model, such as an artificial neural network, built using historical data produced by the aggregator 40. In one embodiment, a deep neural network machine learning model forecasts the aggregation of the demographic features 24 using the historical data with more layers than the typical three layers of multilayer perceptron used by an artificial neural network. The deep neural network structure increases the feature abstraction capability of neural networks.

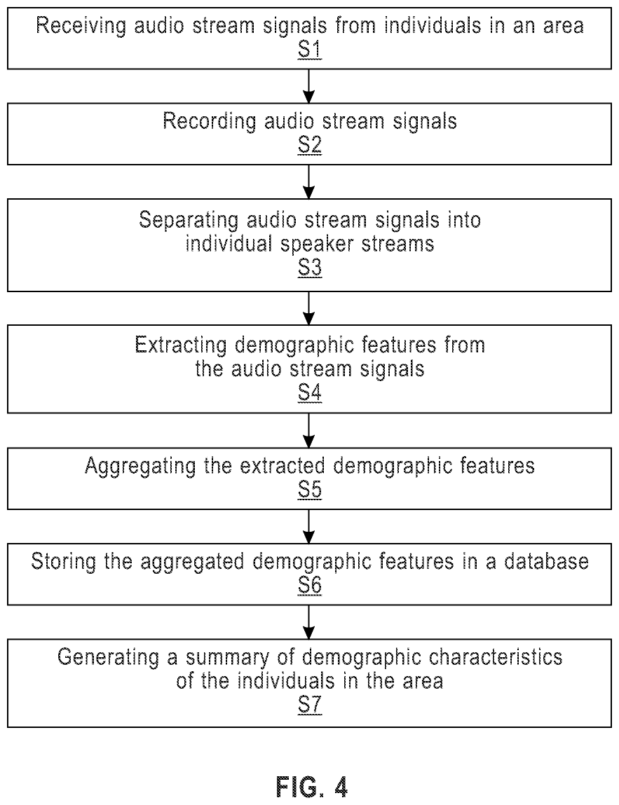

FIG. 4 is one embodiment of a computer implemented method for extracting demographic features from audio streams in a crowd environment. Step S1 includes receiving audio stream signals from a predefined geographical area containing a plurality of individuals. Step S2 includes recording the received audio stream signals. For example, steps S1 and S2 may be performed by audio streams collector 12. Step S3 includes separating the recorded audio stream signals into individual speaker streams. For example, step S3 may be performed by individual speaker streams decomposer 18. Step S4 includes extracting demographic features from the recorded and separated individual audio stream signals. For example, step S4 may be performed by demographic features extractor 22. In one embodiment step S4 may include aggregating the extracted demographic features at different levels of granularity. In one embodiment, step S3 is omitted or bypassed and step S4 includes extracting demographic features from the recorded audio stream signals received directly from audio streams collector 12. Step S5 includes aggregating the extracted demographic features. For example, step S5 may be performed by aggregator 40. Step S6 includes storing the aggregated demographic features in a database, such as database 43. For example, database 43 may be contained within aggregator 40 or a separate database. Step S7 includes analyzing the aggregated demographic features to generate a summary of demographic characteristics of the plurality of individuals in the predefined geographical area. For example, step S7 may be performed by the aggregator 40.

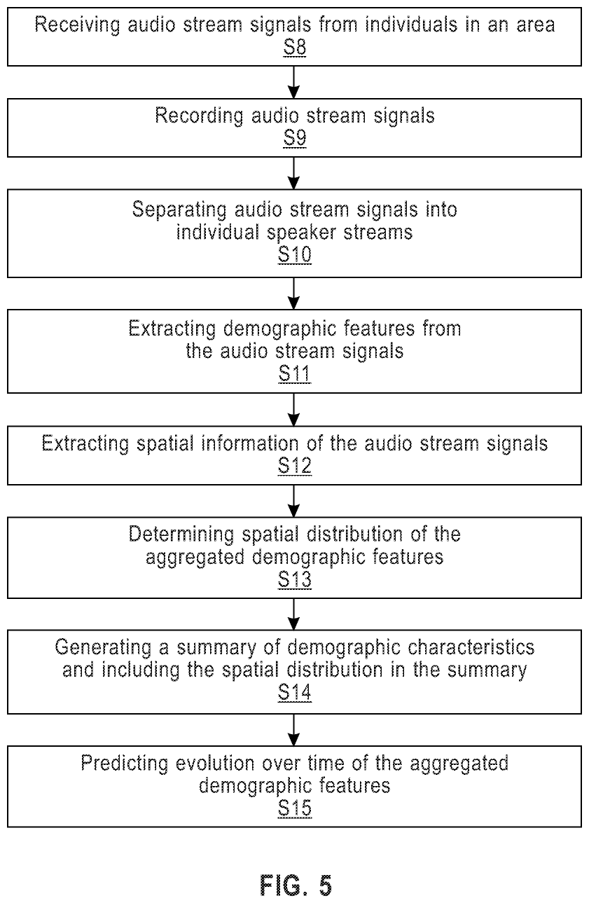

FIG. 5 is one embodiment of a computer implemented method for extracting demographic features from audio streams in a crowd environment, enhanced by spatial information of the audio streams. Steps S8, S9, S10 and S1l are the same as steps S1, S2, S3 and S4 described in connection with FIG. 4 and will not be repeated. Step S12 includes extracting spatial information of the recorded and separated individual audio stream signals within the geographical area. For example, step S12 may be performed by spatial information extractor 26. As with step S3 FIG. 4, step S10 may be omitted or bypassed and step S12 may include extracting demographic features from the recorded audio stream signals received directly from audio streams collector 12. Step S13 includes determining spatial distribution of the aggregated demographic features within the geographical area based on the extracted spatial information. For example, step S13 may be performed by aggregator 40. Step S14 includes generating a summary of demographic characteristics of the plurality of individuals in the predefined geographical area and including the spatial distribution in the summary of demographic characteristics. For example, step S14 may be performed by aggregator 40. Step S15 includes predicting an evolution over time of the aggregated demographic features. For example, step S15 may be performed by prediction engine 54. In one embodiment, step S15 may be performed by a machine learning model within prediction engine 54.

The systems and methods disclosed herein unlock useful information to understand the crowd gathered in an environment, and to build predictive analytics having impact on business. Examples include targeted advertisement, churn prediction, environment optimizations (IoT), etc.

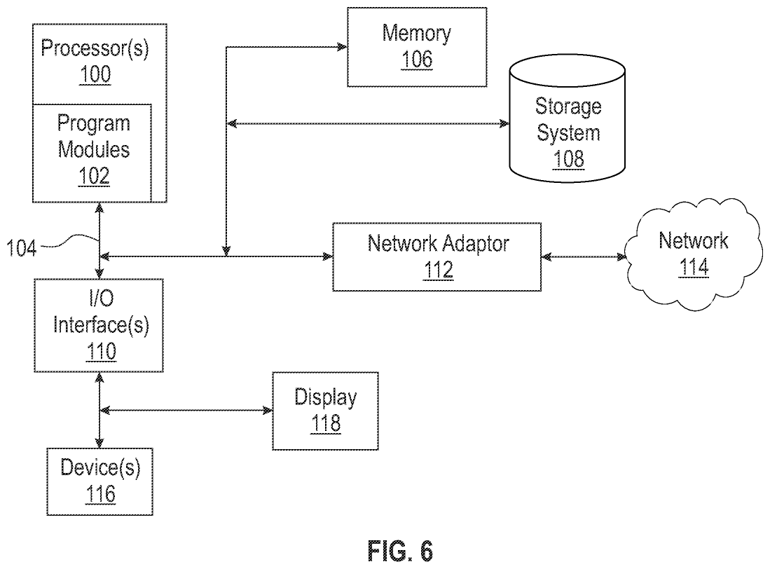

FIG. 6 illustrates a schematic of an example computer or processing system that may implement the method for extracting aggregated demographic features with their spatial distribution from audio streams recorded in a crowded environment in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processors 100 may include one or more program modules 102 that perform the methods described herein. For example, program modules 102 may implement one or more of individual speaker streams decomposer 18, demographic features extractor 22, spatial information extractor 26, aggregator 40 and prediction engine 54. The modules 102 may be programmed into the integrated circuits of the processors 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for extracting demographic features from audio streams in a crowd environment comprising:
receiving audio stream signals from a predefined geographical area containing a plurality of individuals;
recording the received audio stream signals;
extracting demographic features from the recorded audio stream signals;
aggregating the extracted demographic features;
storing the aggregated demographic features in a database; and
analyzing the aggregated demographic features to generate a summary of demographic characteristics of the plurality of individuals in the predefined geographical area.

2. The method of claim 1, wherein the audio signal streams are received by a plurality of microphones arranged in a grid at known locations within geographical area.

3. The method of claim 1, further comprising separating the recorded audio stream signals into individual speaker streams.

4. The method of claim 1, further comprising:
extracting spatial information of the recorded audio stream signals within the geographical area;
determining spatial distribution of the aggregated demographic features within the geographical area based on the extracted spatial information; and
including the spatial distribution in the summary of demographic characteristics.

5. The method of claim 1, further comprising predicting an evolution over time of the aggregated demographic features.

6. The method of claim 1, further comprising aggregating the extracted demographic features at different levels of granularity.

7. The method of claim 5, further comprising using a machine learning model to predict the evolution over time of the aggregated demographic features.

8. A computer system for extracting demographic features from audio streams in a crowd environment, comprising:
one or more computer processors;
one or more non-transitory computer-readable storage media;
program instructions, stored on the one or more non-transitory computer-readable storage media, which when implemented by the one or more processors, cause the computer system to perform the steps of:
receiving audio stream signals from a predefined geographical area containing a plurality of individuals;
recording the received audio stream signals;
extracting demographic features from the recorded audio stream signals;
aggregating the extracted demographic features;
storing the aggregated demographic features in a database; and
analyzing the aggregated demographic features to generate a summary of demographic characteristics of the plurality of individuals in the predefined geographical area.

9. The system claim 1, wherein the audio signal streams are received by a plurality of microphones arranged in a grid at known locations within geographical area.

10. The system claim 1, further comprising separating the recorded audio stream signals into individual speaker streams.

11. The system claim 1, further comprising:
extracting spatial information of the recorded audio stream signals within the geographical area;
determining spatial distribution of the aggregated demographic features within the geographical area based on the extracted spatial information; and
including the spatial distribution in the summary of demographic characteristics.

12. The system claim 1, further comprising predicting an evolution over time of the aggregated demographic features.

13. The system claim 1, further comprising aggregating the extracted demographic features at different levels of granularity.

14. The system claim 5, further comprising using a machine learning model to predict the evolution over time of the aggregated demographic features.

15. A computer program product comprising program instructions on a computer-readable storage medium, where execution of the program instructions using a computer causes the computer to perform a method for extracting demographic features from audio streams in a crowd environment, comprising:
recording the received audio stream signals;
extracting demographic features from the recorded audio stream signals;
aggregating the extracted demographic features;
storing the aggregated demographic features in a database; and
analyzing the aggregated demographic features to generate a summary of demographic characteristics of the plurality of individuals in the predefined geographical area.

16. The computer program product of claim 1, wherein the audio signal streams are received by a plurality of microphones arranged in a grid at known locations within geographical area.

17. The computer program product of claim 1, further comprising separating the recorded audio stream signals into individual speaker streams.

18. The computer program product of claim 1, further comprising:
extracting spatial information of the recorded audio stream signals within the geographical area;
determining spatial distribution of the aggregated demographic features within the geographical area based on the extracted spatial information; and
including the spatial distribution in the summary of demographic characteristics.

19. The computer program product of claim 1, further comprising predicting an evolution over time of the aggregated demographic features.

20. The computer program product of claim 1, further comprising aggregating the extracted demographic features at different levels of granularity.
